(19) United States
(12) Patent Application Publication
(10) Pub. No.: US 2013/0121911 A1
(43) Pub. Date: May 16, 2013

(54) PELLETIZED MOLECULAR SIEVES AND METHOD OF MAKING MOLECULAR SIEVES

(71) Applicant: Sandia Corporation, Albuquerque, NM (US)

(72) Inventors: Tina M. Nenoff, Sandia Park, NM (US); Dorina Florentina Sava, Albuquerque, NM (US)

(73) Assignee: Sandia Corporation, Albuquerque, NM (US)

(21) Appl. No.: 13/674,777

(22) Filed: Nov. 12, 2012

Related U.S. Application Data
(60) Provisional application No. 61/558,240, filed on Nov. 10, 2011.

(51) Int. Cl. C01B 39/00; C04B 35/622

(52) U.S. Cl. 423/700; 264/117

(57) ABSTRACT

A shaped body formed of a crystalline molecular sieve powder is disclosed. The shaped body may be formed of crystalline metal-organic framework (MOF). The shaped body is formed with no reduction in sorption capacity or accessible surface area compared to the initial crystalline molecular sieve powder.

### CROSS-REFERENCE TO RELATED APPLICATIONS

This application claims priority to U.S. Provisional Patent Application 61/558,240, entitled “PELLETIZED MOLECULAR SIEVES AND METHOD OF MAKING PELLETIZED MOLECULAR SIEVES”, filed Nov. 10, 2011, the specification thereof is incorporated herein by reference in the entirety.

### STATEMENT OF GOVERNMENT INTEREST

The United States Government has rights in this invention pursuant to Contract No. DE-AC04-94AL85000 between the United States Department of Energy and Sandia Corporation, for the operation of the Sandia National Laboratories.

### FIELD

The present disclosure is generally directed to pelletized molecular sieves and a method of making pelletized molecular sieves, and is more particularly directed to a method of making pelletized molecular sieves with no reduction in sorption capacity or accessible surface area from the starting molecular sieve material.

### BACKGROUND

Materials having a large internal surface area defined by open pores or channels are of interest for applications such as, but not limited to nuclear and industrial waste cleanup and storage materials, bulk gas separations, catalysis, ion exchange, chromatography, sorbents, breathing apparatus/face masks and sensor components. These materials include molecular sieves, which are materials containing tiny pores of a precise and uniform size that may be used as an absorbent for gases and liquids. Molecules small enough to pass through the pores are adsorbed while larger molecules are not. It is different from a common filter in that it operates on a molecular level and traps the adsorbed substance

Molecular sieves are generally obtained as small crystallites or powders, which are processed to form larger, shaped bodies of the molecular sieve material. The prior art processes by which the crystalline molecular sieve materials have been formed into larger, shaped bodies reduces the accessible internal surface area and/or crystalline structure of the molecular sieve material, thereby reducing the overall sorption capacity of the crystalline, molecular sieve shaped body. The decrease may be from, but not limited to, the collapse of internal pore structure from processing pressure, pore pathway blockage due to compression of powder, and/or pore blockage from processing binders.

In one type of molecular sieves, metal-organic frameworks (MOFs), this discrepancy is attributed to the collapse, closing or restriction of porous pathways between MOF particles, to internal MOF channels that collapse after solvent removal, or to residual solvent or unreacted reagent molecules. This collapses and/or constrictions, blocking of access to some adsorption sites by errant molecules, thereby limiting the materials' full potential for catalysis or for purifying and storing molecules, including gas molecules such as H₂, CO₂, and CH₄.

The need remains, therefore, for a shaped body formed of molecular sieve material with no reduction in sorption capacity or accessible surface area relative to the molecular sieve starting material. The need also remains for molecular sieve shaped bodies, such as pellets, that can be easily handled in industrial settings within apparatus and in applications. The need also remains to provide molecular sieve material in a form, such as a shaped body, so as not to lose material, that also allows for good fluid/gas flow through material. The need also remains to provide molecular sieve material in a shaped body so as not to lose material during operations, for example by being not suck-up or suck-through as dust in the process.

### SUMMARY OF THE DISCLOSURE

In an exemplary embodiment, a shaped body formed of a crystalline molecular sieve powder is disclosed. The shaped body is formed with no reduction in sorption capacity or accessible surface area relative to the starting or initial crystalline molecular sieve powder material.

According to one embodiment, a shaped body formed of a crystalline metal-organic framework powder is disclosed. The shaped body has no reduction in sorption capacity or accessible surface compared to the initial crystalline metal-organic framework powder.

According to another embodiment of the present invention, a method is disclosed that includes mixing a crystalline molecular sieve powder with a shaping component to form a mixture; shaping the mixture to form a shaped mixture; and activating the shaped mixture to form a shaped molecular sieve material. Activating the shaped mixture removes substantially all of the shaping component from the mixture.

One advantage of the present disclosure is to provide a method of forming a shaped body of a crystalline molecular sieve material having no reduction in sorption capacity or accessible surface area compared to the initial crystalline molecular sieve powder from which the shaped body is formed.

Another advantage of the present disclosure is to provide usable material for industrial apparatus without high static charge.

Another advantage of the present disclosure is to provide usable material without high dust content.

Another advantage of the present disclosure is to provide usable material without inhalation ES&H or equipment clogging downstream concerns.

Other features and advantages of the present disclosure will be apparent from the following more detailed description of the preferred embodiment, taken in conjunction with the accompanying drawings which illustrate, by way of example, the principles of the disclosure.

### BRIEF DESCRIPTION OF THE DRAWINGS

FIG. 1 is an illustration of a shaped body according to an embodiment of the invention.

FIG. 2 is a flow chart of a method of forming a shaped molecular sieve body according to an embodiment of the present disclosure.

FIG. 3 illustrates the results of gas adsorption analysis in an example of an embodiment of the present disclosure.

Wherever possible, the same reference numbers will be used throughout the drawings to represent the same parts.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete and will fully convey the scope of the invention to those skilled in the art.

The present disclosure is directed to shaped bodies is formed of crystalline molecular sieve powder with no reduction in sorption capacity or accessible surface area relative to the initial crystalline molecular sieve powder and methods of making these shaped bodies. Hereinafter, the term “crystalline molecular sieve” will be referred to as “molecular sieve”.

The term “molecular sieve” refers to a particular property of these materials, i.e., the ability to selectively sort molecules based primarily on a size exclusion process. This is due to a very regular pore structure of molecular dimensions. The maximum size of the molecular or ionic species that can enter the pores is controlled by the dimensions of the channels. In an embodiment, the pores of the crystalline molecular sieve powder may be between 4 Å-100 Å. In another embodiment, the pores of the crystalline molecular sieve power may be as large as 10 nm, for material, such as, cut not limited to crystalline porous anatase (TiO₂).

The initial molecular sieve powder is selected from a group including aluminosilcate minerals, clays, porous glasses, micro-porous charcoals, zeolites, and synthetic compounds that have open structures through which small molecules can diffuse. The synthetic compounds include crystalline porous metal-organic frameworks (MOFs). The initial molecular sieve powder may be activated or non-activated.

The initial molecular sieve powder has an average particle size between about 5 μm and about 250 μm. In another embodiment, the initial molecular sieve powder may have an average particle size between about 5 μm and about 50 μm. In another embodiment, the initial molecular sieve material is selected to have an average particle size of about 5 μm.

MOFs are metal clusters interconnected by organic linker groups, a design that endows the materials with large pores, open channels, and huge internal surface areas for adsorbing molecules. MOFs are highly porous crystalline materials, with a very diverse structural and chemical profile. A large set of metal and organic linkers are available. As such, MOFs can be categorized following several criteria, including topology (ex. MOFs with zeolitic topologies: zeolitic imidazolate frameworks (ZIF5), zeolite-like metal-organic frameworks (ZMOFs), or based on the organic linkers they include: carboxylate-based MOFs, N-based linker MOFs, N-O-heterofunctional linkers based MOFs. Crystalline MOFs include ZIF-8 and HUST-1.

The framework of ZIF-8 has a chemical composition of ZnL2 (wherein L=2-Methylimidazolate, i.e., the anion of 2-Methylimidazole) and a topology defined by the Zn cations that is identical to the zeolitic framework type SOD. SOD is a three letter framework type code as defined by the International Zeolite Association (“IZA”) in the “Atlas of Zeolite Framework Types” (Ch. Baerlocher, L. B. McCusker, D. H. Olson, Sixth Revised Edition, Elsevier Amsterdam, 2007).

The framework of HUST-1 is [Cu₃(benzene-1,3,5-carboxylate)₂. HKUST-1 is a highly porous metal coordination polymer [Cu₃(TMA)₂(H₂O)₃]ₙ where TMA is benzene-1,3,5-tricarboxylate. It has interconnected [Cu₂(O₂CR)₄] units (where R is an aromatic ring), which create a three-dimensional system of channels with a pore size of 1 nanometer and an accessible porosity of about 40 percent in the solid.

Zeolites are microporous, aluminosilicate materials. Zeolites have a porous structure that can accommodate a wide variety of cations, such as Na⁺, K⁺, Ca²⁺, Mg²⁺ and others. These positive ions are rather loosely held and can readily be exchanged for others in a contact solution. In one embodiment, a zeolite starting material is selected from a group including catalysis, pressure swing adsorption, gas separations, ion exchange, chromatography, and gas sorption zeolites. Examples of zeolites and their various cation exchange versions that may be used include, but are not limited to, Zeolites X and Y (faujasite structure) that may be used as catalysts and selective adsorbents, and Zeolite A, which may be used in pressure swing adsorption applications for O₂ purification, mineral zeolites such as mordenite for gas sorption and nuclear fission gas capture, and heulendite and clinoptilolite, which may be used in water purification processes.

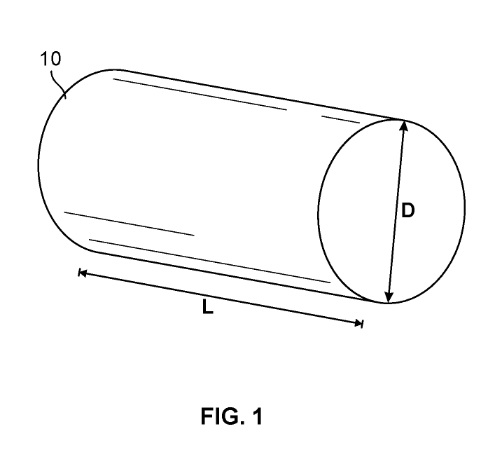

FIG. 1 illustrates a shaped body 10 according to an exemplary embodiment of the present disclosure. In this exemplary embodiment, the shaped body 10 has a generally cylindrical shape having a length L and a diameter D. In an embodiment, the length L may be from about 1 mm to about 20 mm. In an embodiment, the diameter D may be from about 1 mm to about 5 mm. In another embodiment, the shaped body may have another general geometry, such as, but not limited to rods, spheres, pellets, briquettes, squares, rectangles or other complex shape.

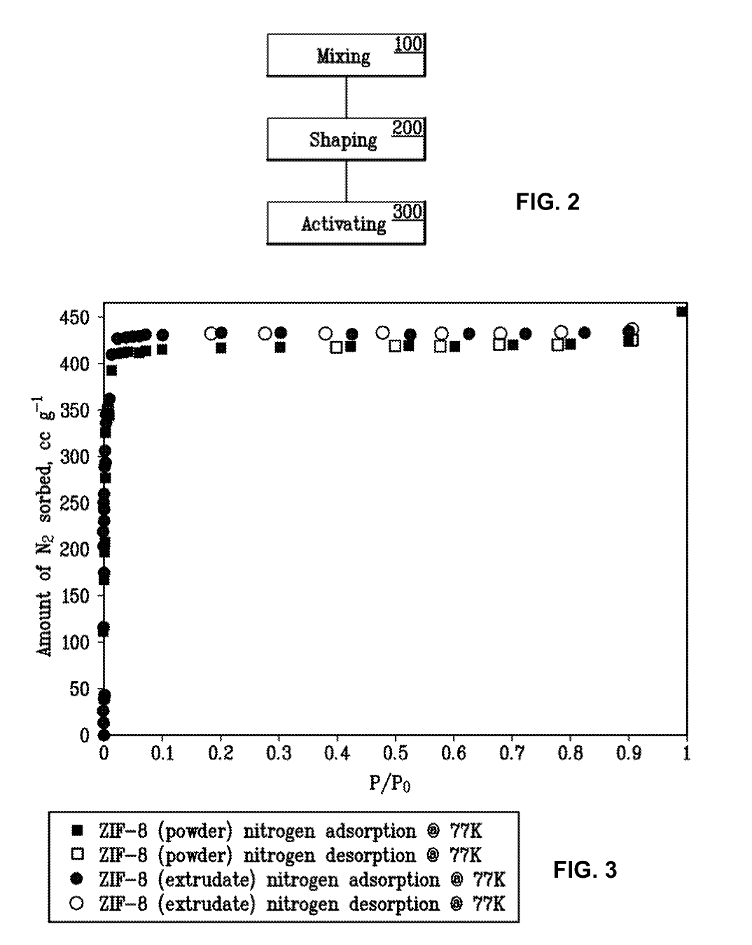

FIG. 2 shows the general process steps for forming the shaped body according to the invention. According to the present disclosure, the shaped body is formed of a molecular sieve material by a method including the following steps: mixing a molecular sieve powder with a shaping component: shaping the mixture: removing the shaping component; and activating the molecular sieve material.

According to a first step 100, which may be referred to as a mixing step, an initial molecular sieve powder is selected and mixed with a shaping component. The initial molecular sieve powder may be selected from a group of molecular sieve materials including, but not limited to aluminosilcate minerals, clays, porous glasses, micro-porous charcoals, zeolites, and synthetic compounds that have open structures through which small molecules can diffuse. The synthetic compounds include, but are not limited to crystalline porous metal-organic frameworks (MOFs). In one embodiment, the initial crystalline MOF powder may be selected from the group including ZIF-8 and HKUST-1.

The shaping component is a volatile liquid. In an embodiment, the shaping component may be a solvent selected from a group including inorganic and organic solvents. In an embodiment, the shaping component may be selected from a group including water, alcohols and ketones. Not wishing to be bound by any theory, the shaping component may or may not provide a solvent, binder and/or lubricant function during the shaping process. The shaping component must be selected to be substantially removed from the molecular sieve material during the activation or shaping component removal step.

The shaping component and initial molecular sieve material are mixed to form a mixture. The amount of shaping component is selected to form a self-supporting mixture. In an embodiment, the amount of shaping component in the mixture is between about 0.1 wt. % and 0.3 wt. %. In another embodiment, the amount of shaping component in the mixture is between about 0.15 wt. % and 0.2 wt. %.

According to a second step 200, which may be referred to as a shaping step, the mixture is shaped. The mixture may be shaped by extruding, casting, pressing or other shaping technique to form a shaped mixture. In an embodiment, the mixture may be extruded by a syringe. The shaping technique is selected so as not to change the crystalline structure of the initial molecular sieve powder.

The shaping step 200 forms a shaped mixture having any geometric shape. In an embodiment, the shaping step 200 may form a cylindrical, spherical, rectangular, pellet or other geometric shape. In an embodiment, the shaping step 200 is used to form a pellet shape. In another embodiment, the shaping step 200 forms a pellet having a diameter of between about 1 mm and about 5 mm and a length between about 5 mm and 15 mm. In another embodiment, the shaping step 200 forms a pellet having a diameter of 3 mm and a length of about 10 mm. The shaped mixture is self-supporting.

According to a third step 300, which may be referred to as an activation step, the shaping component is removed from the shaped mixture. The activation step 300 removes the shaping component molecules that block access to some adsorption sites, thereby allowing the molecular sieve material to realize its full adsorption potential. In an embodiment, the activation step 300 completely removes all of the shaping component from the shaped mixture. In another embodiment, the activation step 300 removes substantially all of the shaping component from the shaped mixture. In this disclosure, the term “removes substantially all” is defined as removing equal to or greater than 99.8%. In another embodiment, the shaping component is completely removed during activation.

The activation step 300 is performed by heating the shaped mixture to a temperature above the vaporization temperature of the shaping component. In an embodiment, the activation temperature may be above 50° C. In an embodiment, the activation temperature may be above 75° C. In another temperature, the activation temperature may be between 100° C. and 300° C. In another temperature, the activation temperature may be between 100° C. and 150° C. The activation temperature is the temperature at which any occluded shaping component molecules (molecules in the pores) are removed while allowing the maintaining of the framework structure (does not cause collapse of the framework). The activation temperature, while selected to be above the shaping component vaporization temperature, is also selected to be below the temperature upon which the crystalline structure of the molecular sieve material is changed

The shaped molecular sieve body produced by the disclosed method has the same or substantially the same crystalline structure, accessible surface area, and sorption capacity as the initial molecular sieve powder. In an embodiment, the shaped molecular sieve body has the same or substantially the same crystalline structure, accessible surface area, and sorption capacity as the initial molecular sieve powder, when the initial molecular sieve power is substantially activated as the initial powder. In another embodiment, the shaped molecular sieve body has the same, substantially the same crystalline structure, and substantially the same or greater than accessible surface area and sorption capacity as the initial molecular sieve powder, when the initial molecular sieve power is less than substantially activated.

The shaped molecular sieve body formed by the macro-scale shaping of the molecular sieve powder produces a molecular sieve body that is easily manipulated by hand, machinery, other handling technique in industrial settings with little or no dust or powder dispersed into the air in the form of microcrystalline powder. Additionally, the shaped molecular sieve body is self-supporting. The term “self-supporting” is well understood in the art and is defined herein as having a crush strength allowing for operator or machine handling with substantially no shaped body disintegration.

The shaped body may be used for nuclear and industrial waste cleanup and storage materials, bulk gas separations, catalysis, ion exchange, chromatography, sorbents, breathing apparatus/face masks and sensor components. The shaped body can adsorb selected ions and/or compounds from a gas or liquid fluid. In an embodiment, the adsorbed material may be adsorbed from a liquid and may be selected from a group including, but not limited to alkali, lanthanide ion, TcO₄⁻, arsenate, iodite, iodate and heavy metal ions. In an embodiment, the alkali may be an alkali earth ion selected from the group including, but not limited to Cs⁺, Sr²⁺, and Ba²⁺. In an embodiment, the adsorbed material may be adsorbed from a gas and may be selected from a group including, but not limited to fission gases, syngas components, and dehydration products. In an embodiment, the fission gases may be selected from the group including, but not limited to iodine (I₂), xenon and krypton. In an embodiment, the syngas component may be selected from the group including, but not limited to CO₂, H₂, CO, and CH₄. In an embodiment, the dehydration product may be selected from the group including, but not limited to ethane and propane. In an embodiment, the shaped body may be used for purifying and storing molecules, including but not limited to gas molecules such as H₂, CO₂, and CH₄.

According to another embodiment of the invention, a waste form is disclosed that includes the shaped body as disclosed above having adsorbed a waste material. The waste material may be any one or combination of ions and/or compounds as disclosed above. The waste form may be formed by the shaped body adsorbing an ion and/or compound from a fluid, which may be a liquid or a gas, by any molecular sieve adsorption method as known in the art.

### Example 1

A mixture was extruded from a homogeneous paste formed from 1 gram of activated powder ZIF-8 and 2 mL of water. The shaped mixture was in the form of individual cylindrical pellets of approximately 3 mm in diameter and 10 mm in length. The shaped mixture was activated at 300° C. for 4 hours in order to remove any water content.

Gas adsorption isotherms were measured at 77 K, using a Micromeritics ASAP 2020 surface area and porosity analyzer. Nitrogen of ultra-high purity 99.999% (Matheson Tri-Gas) was used in these experiments. The isotherms were measured on the powder, as well as extruded form of pristine ZIF-8, and are shown on FIG. 3.

As can be seen in FIG. 3, the isotherms of the initial ZIF-8 powder and the formed ZIF-8 shaped body had the same isotherms indicating that the extrusion methodology did not adversely affect the performance of the material and did not produce changes in the original crystalline framework or its pore size and volume. Furthermore, a slightly higher specific surface area (SSA) of the extrudate form is was observed: BET_{extrudate}=1837 m²g⁻¹ (Langmuir_{extrudate}=1932 m²g⁻¹), BET_{powder}=1766 m²g⁻¹ (Langmuir_{powder}=1857 m²g⁻¹), resulting also in a higher uptake in this form versus the powdered form.

The invention being thus described, it will be obvious that the same may be varied in many ways. Such variations are not to be regarded as a departure from the spirit and scope of the invention, and all such modifications as would be obvious to one skilled in the art are intended to be included within the scope of the appended claims. It is intended that the scope of the invention be defined by the claims appended hereto. The entire disclosures of all references, applications, patents and publications cited above are hereby incorporated by reference.

In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A shaped body consisting essentially of an agglomerated molecular sieve material.

2. The shaped body of claim 1, wherein the agglomerated molecular sieve material has substantially the same gas adsorption isotherm as an initial molecular sieve powder from which the shaped body is formed.

3. The shaped body of claim 2, wherein the agglomerated molecular sieve material has substantially equal specific surface area as the initial molecular sieve powder.

4. The shaped body of claim 2, wherein the initial molecular sieve power is selected from the group consisting of crystalline metal organic frameworks and zeolites.

5. The shaped body of claim 2, wherein the initial molecular sieve powder is ZIF-8.

6. The shaped body of claim 1, wherein the shaped body is self-supporting.

7. A method of making a shaped body, comprising:
mixing a crystalline molecular sieve powder with a shaping component to form a mixture;
shaping the mixture to form a shaped mixture; and
activating the shaped mixture to form the shaped body consisting essentially of the crystalline molecular sieve powder that has been agglomerated;
wherein activating the shaped mixture removes substantially all of the shaping component.

8. The method of claim 7, wherein the crystalline molecular sieve powder is a crystalline metal-organic framework or a zeolite.

9. The method of claim 7, wherein the crystalline molecular sieve powder is ZIF-8.

10. The method of claim 7, wherein the shaping component is selected from a group consisting of water, alcohols and ketones.

11. The method of claim 7, wherein the mixture is shaped by extrusion.

12. The method of claim 7, wherein the shaped mixture is activated by heating the shaped mixture at a temperature greater than about 100° C.

13. The method of claim 7, wherein the shaped body is self-supporting.

14. A shaped body produced by the method of claim 7.
